(19) United States
(12) Patent Application Publication
(10) Pub. No.: US 2026/0097621 A1
(43) Pub. Date: Apr. 9, 2026

(54) SADDLED VEHICLE

(71) Applicant: HONDA MOTOR CO., LTD., Minato-ku, Tokyo (JP)

(72) Inventor: Yosuke Wada, Tokyo (JP)

(21) Appl. No.: 19/113,433

(22) PCT Filed: Sep. 20, 2023
(86) PCT No.: PCT/JP2023/034104

§ 371 Date: Mar. 20, 2025

(30) Foreign Application Priority Data
Sep. 28, 2022 (JP) 2022-154479

(51) Int. Cl. B60G 17/027; B62J 50/22; B62K 25/28

(52) U.S. Cl. CPC B60G 17/0272; B62J 50/22; B62K 25/283; B60G 2300/12; B60G 2400/204; B60G 2400/252

(57) ABSTRACT

A saddled vehicle includes: an adjustment unit that adjusts the height of a seat; and a control device that controls the adjustment unit to adjust the height. The control device includes: a height acquisition unit that acquires the height; a velocity acquisition unit that acquires a velocity at which the saddled vehicle travels; and a display control unit that displays an alert on a display unit when, during travelling of the saddled vehicle, the velocity is no more than a first predetermined value and, also, the height differs from the height at a time of starting of travelling of the saddled vehicle.

### TECHNICAL FIELD

The present invention relates to a saddled vehicle.

### BACKGROUND ART

JP 2021-123174 A discloses a vehicle height adjusting device for adjusting the height of a seat of a saddled vehicle. JP 2014-065388 A discloses a vehicle height adjusting device for performing a vehicle height lowering operation for canceling a vehicle height raising operation when a motorcycle is stopped.

### SUMMARY OF THE INVENTION

As disclosed in JP 2021-123174 A, in the case that the height of a seat is changed during traveling of a saddled vehicle, the foot grounding property of a rider changes between before the saddled vehicle is started to travel and when the saddled vehicle is stopped. Therefore, when the saddled vehicle stops, the rider may fall down together with the saddled vehicle. This is a problem in terms of safety.

In off-road traveling of a saddled vehicle, a stoppage and a start are frequently repeated. It is troublesome for a rider to perform the vehicle height lowering operation as disclosed in JP 2014-065388 A every time the vehicle is stopped. There is a long-awaited need for more useful safety improvement measures.

The present invention has the object of solving the aforementioned problem. In turn, the present invention contributes to the development of a sustainable transportation system by further improving the road safety.

An aspect of the present invention is a saddled vehicle including an adjustment unit configured to adjust a height of a seat of the saddled vehicle, and a control device configured to control the adjustment unit to adjust the height of the seat, wherein the control device includes a height acquisition unit configured to acquire the height of the seat, a speed acquisition unit configured to acquire a speed at which the saddled vehicle travels, and a display control unit configured to display an alert on a display unit in a case that, during traveling of the saddled vehicle, a condition is satisfied that the speed is equal to or less than a first predetermined value and the height is different from the height at a start of the traveling of the saddled vehicle.

According to the present invention, safety can be enhanced.

### BRIEF DESCRIPTION OF DRAWINGS

FIG. 1 is a side view of a saddled vehicle;

FIG. 2 is a diagram illustrating the structure of a suspension and an adjustment unit of the suspension;

FIG. 3 is a block diagram schematically illustrating a configuration of a control device mounted in the saddled vehicle;

FIG. 4A is a diagram illustrating an example of how the speed of the saddled vehicle changes in accordance with time,

and FIG. 4B is a diagram illustrating another example of how the speed of the saddled vehicle changes in accordance with time;

FIG. 5 is a diagram illustrating an example of an alert displayed on a display unit;

FIG. 6 is a flowchart illustrating a processing sequence of an alert display process regarding a change in the height of a seat performed by a control device;

FIG. 7 is a flowchart illustrating a processing sequence of the alert display process regarding a change in the height of the seat performed by the control device;

FIG. 8A is a diagram illustrating a screen example of the display unit that displays a result of a mode selected by a rider of the saddled vehicle, and FIG. 8B is a diagram illustrating an example of the types of modes;

FIG. 9 is a diagram illustrating an example of an alert displayed on the display unit; and

FIG. 10 is a diagram illustrating a screen example of the display unit displaying a result of inputting a set value of a seat height to the control device by the rider of the saddled vehicle.

### DETAILED DESCRIPTION OF THE INVENTION

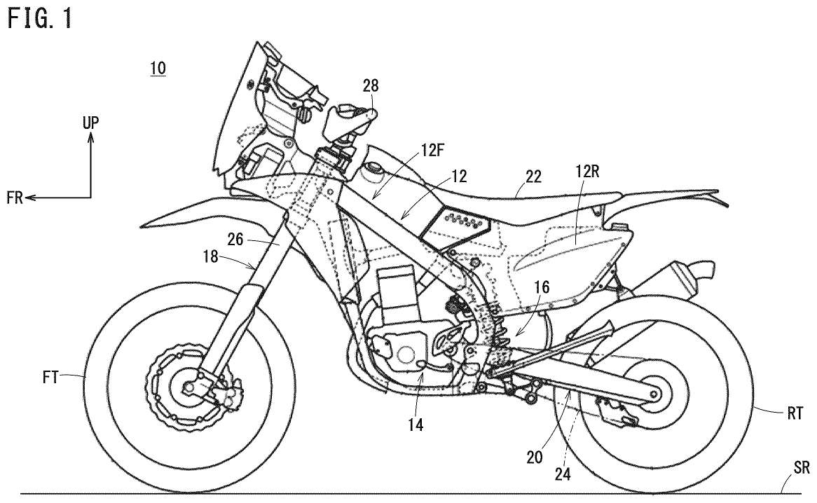

FIG. 1 is a side view of a saddled vehicle 10. In FIG. 1, the saddled vehicle 10 disposed on a road surface SR (upward UP with respect to the road surface) can travel forward FR. The saddled vehicle 10 has a vehicle body frame 12, an engine 14, a suspension 16, a steering system 18, swing arms 20, and a seat 22.

The vehicle body frame 12 includes a front frame 12F and a rear frame 12R. The front frame 12F is disposed at the front portion of the saddled vehicle 10. The rear frame 12R is disposed at the rear portion of the saddled vehicle 10. The swing arms 20 are attached to the vehicle body frame 12 and are disposed at the rear portion of the saddled vehicle 10. The swing arms 20 support a rear wheel RT. The engine 14 is supported by the vehicle body frame 12. The output of the engine 14 is transmitted to the rear wheel RT by a chain 24. In this way, the engine 14 drives the rear wheel RT.

The steering system 18 is disposed at the front end of the front frame 12F. The steering system 18 includes a pair of front forks 26 and a handlebar 28. One of the pair of front forks 26 is shown in FIG. 1. Another of the pair of front forks 26 is provided on the side of the saddled vehicle 10 opposite to the side shown in FIG. 1. The handlebar 28 is disposed at the upper ends of the pair of front forks 26. A front wheel FT is disposed at the lower ends of the pair of front forks 26.

The seat 22 is provided above the rear frame 12R. When the rider of the saddled vehicle 10 rides on the saddled vehicle 10, the rider sits astride the seat 22. The suspension 16 is disposed between the swing arms 20 and the vehicle body frame 12. A coil spring 54 of the suspension 16 expands and contracts with the vertical swing of the swing arms 20. In this way, the suspension 16 absorbs the shock that the saddled vehicle 10 receives from the road surface SR, and suppresses the swinging of the rider. The height of the seat 22 of the saddled vehicle 10 is adjustable.

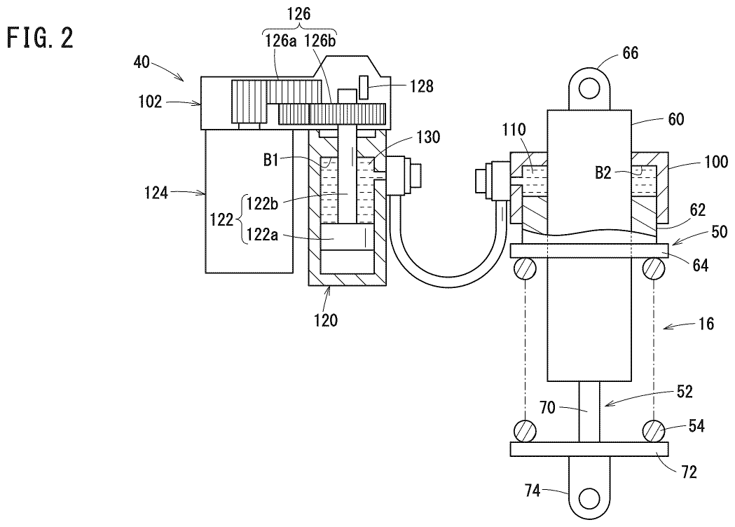

FIG. 2 is a diagram illustrating the structure of the suspension 16 and an adjustment unit 40 of the suspension 16. The suspension 16 includes a cylinder member 50, a piston member 52, and the coil spring 54. The cylinder member 50 includes a cylinder body 60, a cylindrical portion 62, a spring receiving portion 64, and a vehicle body connecting portion 66. The piston member 52 includes a piston body 70, a spring receiving portion 72, and a wheel connecting portion 74.

The vehicle body connecting portion 66 of the cylinder member 50 is connected to the front frame 12F. The wheel connecting portion 74 of the piston member 52 is connected to the swing arms 20. The inside of the cylinder body 60 is filled with, for example, hydraulic oil. The piston body 70 is slidable in the cylinder body 60 in the axial direction of the cylinder body 60.

The coil spring 54 of the suspension 16 is disposed between the spring receiving portion 64 of the cylinder member 50 and the spring receiving portion 72 of the piston member 52. The adjustment unit 40 of the suspension 16 applies a load to the suspension 16. When the load is applied to the suspension 16, the coil spring 54 is in a compressed state. The coil spring 54 biases the piston member 52 in the direction in which the coil spring 54 expands.

The cylindrical portion 62 engages with the cylinder body 60 so as to cover a part of the outer peripheral surface of the cylinder body 60. The cylindrical portion 62 is relatively slidable on the outer peripheral surface of the cylinder body 60 in the axial direction of the cylinder body 60. When the cylindrical portion 62 is moved by the sliding, the spring receiving portion 64 is also moved. As described below, when the adjustment unit 40 presses the cylindrical portion 62, the spring receiving portion 64 moves in the directions of expansion and contraction of the coil spring 54.

The adjustment unit 40 adjusts the height of the seat 22 of the saddled vehicle 10. An example of the height adjustment of the seat 22 by the adjustment unit 40 will be described below, but the height adjustment of the seat 22 is not limited to the following description. The adjustment unit 40 includes a fluid storing member 100 and a fluid supply unit 102. The fluid storing member 100 has a bottomed cylindrical shape and is fixed to the cylinder member 50. The fluid storing member 100 surrounds the cylindrical portion 62 covering a part of the outer peripheral surface of the cylinder body 60 and an outer peripheral surface of the cylinder body 60 not covered by the cylindrical portion 62. A space is formed between the fluid storing member 100 and the cylindrical portion 62. This space is a fluid chamber 110 in the fluid storing member 100.

The fluid supply unit 102 supplies fluid to the fluid chamber 110 in the fluid storing member 100. The supplied fluid is stored in the fluid chamber 110. As described above, the fluid storing member 100 is fixed to the cylinder member 50. The cylindrical portion 62 is movable on the outer peripheral surface of the cylinder body 60. Therefore, the fluid contained in the fluid chamber 110 in the fluid storing member 100 presses the cylindrical portion 62. The spring receiving portion 64 moves in accordance with the pressure received by the cylindrical portion 62, and a load is applied to the suspension 16. When the load is applied to the suspension 16, the height of the seat 22 of the saddled vehicle 10 is adjusted.

The fluid supply unit 102 includes a cylinder 120, a piston 122, a motor 124, a transmission mechanism 126, and a piston position sensor 128. The transmission mechanism 126 includes gears 126a and 126b. The motor 124 rotates the gear 126a of the transmission mechanism 126. The gear 126b of the transmission mechanism 126 further rotates in accordance with the rotation of the gear 126a.

The piston 122 includes a head 122a and a rod 122b. The rod 122b of the piston 122 is connected to the transmission mechanism 126. More specifically, an external thread is provided on the outer circumference of the rod 122b, and the external thread is screw-engaged into the through hole (internal thread) of the gear 126b. The rotation of the motor 124 is converted to linear motion via the transmission mechanism 126. In response to this linear motion, the head 122a of the piston 122 moves in the cylinder 120 in the axial direction of the cylinder 120.

The piston position sensor 128 measures the amount of protrusion of the rod 122b of the piston 122 from the gear 126b. The piston position sensor 128 detects a position P of the head 122a of the piston 122 in the cylinder 120 based on the amount of protrusion of the rod 122b. The position P of the head 122a of the piston 122 is simply referred to as the position P of the piston 122.

A space is formed between the cylinder 120 and the head 122a of the piston 122. This space is a fluid chamber 130 in the cylinder 120. The fluid chamber 130 stores the fluid to be supplied to the fluid chamber 110 in the fluid storing member 100. When the position P of the piston 122 changes, the size of the fluid chamber 130 in the cylinder 120 changes, and therefore the amount of fluid in the fluid chamber 130 also changes. The amount A of fluid stored in the fluid chamber 110 in the fluid storing member 100 changes in accordance with the change in the amount of fluid contained in the fluid chamber 130 in the cylinder 120.

The pressure received by the cylindrical portion 62 changes with the change in the amount of fluid A stored in the fluid chamber 110. Therefore, the spring receiving portion 64 is moved. As a load L applied to the suspension 16 changes, a height H of the seat 22 of the saddled vehicle 10 changes. The relationship among an amount of change AP in a position P of the piston 122, an amount of change AA in the amount of fluid A stored in the fluid chamber 110, an amount of change AL in a load L applied to the suspension 16, and an amount of change AH in a height H of the seat 22 is expressed by the following equations (1) to (3).

The piston position sensor 128 of the fluid supply unit 102 detects the amount of change AP in the position P of the piston 122. The amount of change AA in the amount of fluid A contained in the fluid chamber 110 in the fluid storing member 100 is expressed by the following equation (1) using the amount of change AP in the position P of the piston 122 and a base area B1 of the fluid chamber 130 in the cylinder 120.

$$Δ A = B 1 \cdot Δ P \qquad ( 1 )$$

The amount of change AH in the height H of the seat 22 is expressed by the equation (2) using the amount of change AP in the position P of the piston 122, the base area B1 of the fluid chamber 130 in the cylinder 120, and the base area B2 of the fluid chamber 110 in the fluid storing member 100. The amount of change AL in the load L applied to the suspension 16 is expressed by the equation (3) using the spring constant k of the coil spring 54 and the amount of change AH in the height H of the seat 22.

$$Δ H = ( B 1 / B 2 ) \cdot Δ P \qquad ( 2 )$$

$$Δ L = k \cdot Δ H \qquad ( 3 )$$

The position P of the piston 122 changes as the drive of the motor 124 is adjusted. Therefore, the adjustment unit 40 of the suspension 16 adjusts the drive of the motor 124 to change the height H of the seat 22 of the saddled vehicle 10. When the height H of the seat 22 is changed during traveling of the saddled vehicle 10, the foot grounding property of the rider changes between before the saddled vehicle 10 is started to travel and when the saddled vehicle 10 is stopped. Therefore, when the saddled vehicle 10 is stopped, the rider may fall down together with the saddled vehicle 10.

A control device 150 according to the present embodiment displays an alert indicating that the height H of the seat 22 has been changed when the saddled vehicle 10 is stopped. The alert display can draw the attention of the rider riding on the saddled vehicle 10 with respect to the foot grounding property of the rider. Therefore, safety can be enhanced.

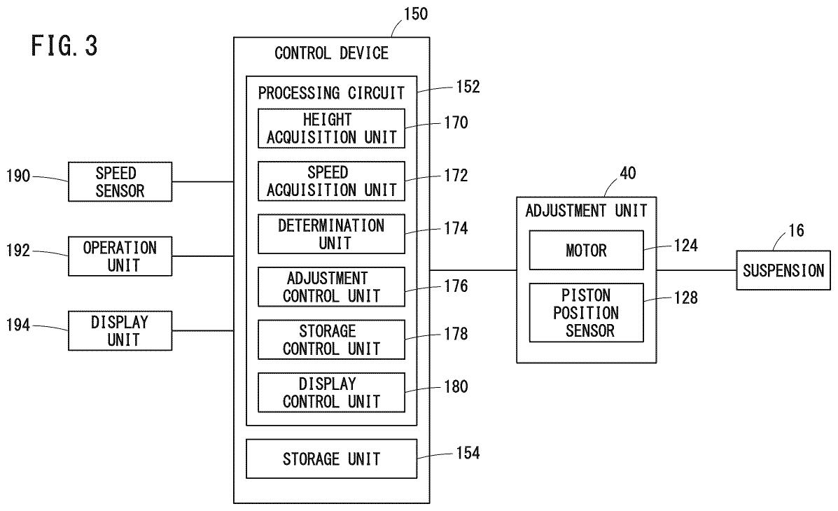

FIG. 3 is a block diagram schematically illustrating a configuration of the control device 150 mounted in the saddled vehicle 10. The control device 150 controls the adjustment unit 40 to adjust the height H of the seat 22 of the saddled vehicle 10. The control device 150 includes a processing circuit 152 and a storage unit 154. The processing circuit 152 includes a processor such as a CPU or a GPU. The storage unit 154 includes a volatile memory such as a RAM or the like, and a non-volatile memory such as a ROM or a flash memory or the like. The volatile memory is used as a working memory of the processor. The non- volatile memory stores programs executed by the processor and other necessary data.

The processing circuit 152 includes a height acquisition unit 170, a speed acquisition unit 172, a determination unit 174, an adjustment control unit 176, a storage control unit 178, and a display control unit 180. When the processing circuit 152 executes the program stored in the storage unit 154, the height acquisition unit 170, the speed acquisition unit 172, the determination unit 174, the adjustment control unit 176, the storage control unit 178, and the display control unit 180 are implemented. At least a part of the height acquisition unit 170, the speed acquisition unit 172, the determination unit 174, the adjustment control unit 176, the storage control unit 178, and the display control unit 180 may be implemented by an integrated circuit such as an ASIC or an FPGA or an electronic circuit including a discrete device.

The height acquisition unit 170 acquires the height H of the seat 22 of the saddled vehicle 10 in which the height H of the seat 22 can be adjusted. The height H of the seat 22 is obtained based on the position P of the piston 122 detected by the piston position sensor 128 of the adjustment unit 40.

The speed acquisition unit 172 acquires the speed at which the saddled vehicle 10 travels based on the sensor data from a speed sensor 190. The speed sensor 190 is attached to at least one of the front wheel FT or the rear wheel RT.

The determination unit 174 determines whether the saddled vehicle 10 has started traveling based on the speed of the saddled vehicle 10. The determination unit 174 determines whether the saddled vehicle 10 has stopped traveling based on the speed of the saddled vehicle 10. The determination unit 174 determines a magnitude relationship between the speed of the saddled vehicle 10 and various predetermined values stored in the storage unit 154, which will be described later. The determination unit 174 further determines whether the height H of the seat 22 obtained is different from the height H of the seat 22 at the start of traveling of the saddled vehicle 10.

The adjustment control unit 176 controls the adjustment unit 40 to adjust the height H of the seat 22 of the saddled vehicle 10. The load L applied to the suspension 16 by the fluid changes in accordance with the rotation of the motor 124 of the adjustment unit 40. The height H of the seat 22 is adjusted in accordance with the load L applied to the suspension 16 of the saddled vehicle 10. An operation unit 192 is, for example, a button of a switch box, or a touchscreen (a touch panel) attached to the handlebar 28. In the present embodiment, the height H of the seat 22 is adjusted in accordance with the operation of the operation unit 192 by the rider during the traveling of the saddled vehicle 10. The height H of the seat 22 may be automatically adjusted during the traveling of the saddled vehicle 10.

The storage control unit 178 stores the height H of the seat 22 at the start of traveling of the saddled vehicle 10 as height information in the storage unit 154. The storage control unit 178 updates the height information stored in the storage unit 154 to the height H of the seat 22 when the traveling of the saddled vehicle 10 is stopped.

When a predetermined condition is satisfied, the display control unit 180 displays an alert on a display unit 194. The display unit 194 is an instrument panel for displaying, for example, the speed of the saddled vehicle 10. When the saddled vehicle 10 stops after the alert is displayed, the display control unit 180 cancels the alert display. As described later, even when a predetermined condition is satisfied, there is a case that the display control unit 180 does not display an alert on the display unit 194 depending on the speed of the saddled vehicle 10.

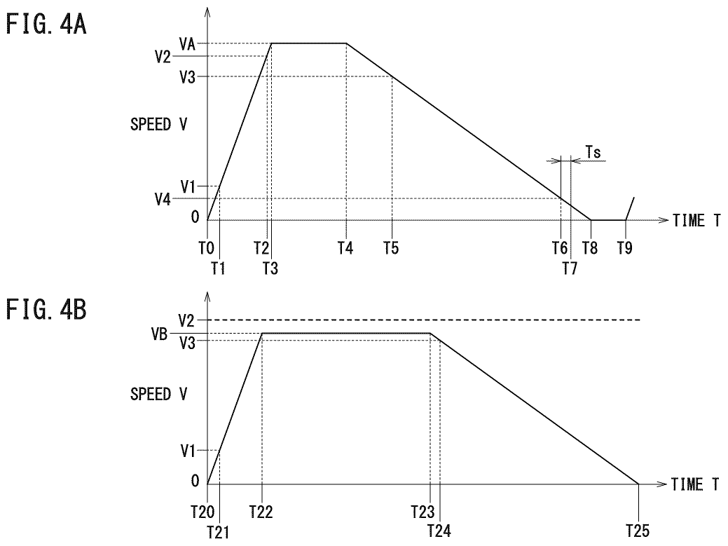

FIG. 4A is a diagram illustrating an example of how the speed V of the saddled vehicle 10 changes in accordance with time T. In the example shown in FIG. 4A, the saddled vehicle 10 starts traveling at time TO. The speed V of the saddled vehicle 10 starts to accelerate from 0. At time T1, the speed V of the saddled vehicle 10 reaches a predetermined value V1. In the case that the speed V exceeds the predetermined value V1, the determination unit 174 of the processing circuit 152 determines that the saddled vehicle 10 has started traveling. The height acquisition unit 170 acquires the height H of the seat 22 of the saddled vehicle 10. The obtained height H of the seat 22 is stored in the storage unit 154 by the storage control unit 178 as height information. The predetermined value V1 is, for example, 7 [km/h].

Thereafter, at time T2, the speed V of the saddled vehicle 10 reaches a predetermined value V2. Subsequently, at time T3, the saddled vehicle 10 stops acceleration, and the constant speed Va of the speed V is maintained until time T4. As shown in FIG. 4A, the constant speed VA is greater than the predetermined value V2. The predetermined value V2 is a value larger than the predetermined value V1, and is, for example, 35 [km/h].

At time T4, the speed V of the saddled vehicle 10 starts to decrease. After the deceleration starts, the speed V of the saddled vehicle 10 drops to a predetermined value V3 at time T5. In the case that the speed V drops to the predetermined value V3 or less, the height acquisition unit 170 acquires the height H of the seat 22 of the saddled vehicle 10. It is assumed that the height H of the seat 22 of the saddled vehicle 10 is changed by the rider operating the operation unit 192 after it has been determined that the saddled vehicle 10 starts traveling at time T1. In this case, the current height H of the seat 22 is different from the height H stored in the storage unit 154 (the height H at the start of traveling of the saddled vehicle 10).

That is, in the example shown in FIG. 4A, during traveling of the saddled vehicle 10, the condition is satisfied that the speed V is equal to or less than the predetermined value V3 and that the current height H of the seat 22 is different from the height H of the seat 22 at the start of traveling of the saddled vehicle 10. In this case, the display control unit 180 displays an alert on the display unit 194. The predetermined value V2 is larger than the predetermined value V3. The predetermined value V3 is, for example, 30 [km/h].

Further, the deceleration continues, and at time T6, the speed V of the saddled vehicle 10 drops to a predetermined value V4. The deceleration continues after time T6 as well. In the case that a time period Ts elapses from time T6 to time T7 while the speed V is equal to or lower than the predetermined value V4, the determination unit 174 determines that the saddled vehicle 10 has stopped traveling. The display control unit 180 cancels the alert display. The height acquisition unit 170 acquires the height H of the seat 22 of the saddled vehicle 10. The storage control unit 178 updates the height information stored in the storage unit 154 to the height H of the seat 22 acquired by the height acquisition unit 170. The predetermined value V4 is, for example, 5 [km/h].

At time T8, the saddled vehicle 10 actually stops, and its speed V becomes 0. In the case that the reason for the stoppage of the saddled vehicle 10 is, for example, waiting for a traffic signal, the saddled vehicle 10 starts traveling again at time T9. As the height H at the start of traveling of the saddled vehicle 10, the height information stored in the storage unit 154 is used.

FIG. 4B is a diagram illustrating another example of how the speed V of the saddled vehicle 10 changes in accordance with time T. In the example shown in FIG. 4B, the saddled vehicle 10 starts traveling at time T20. The speed V of the saddled vehicle 10 starts to accelerate from 0. At time T21, the speed V of the saddled vehicle 10 reaches the above-mentioned predetermined value V1. In the case that the speed V exceeds the predetermined value V1, the determination unit 174 of the processing circuit 152 determines that the saddled vehicle 10 has started traveling. The height acquisition unit 170 acquires the height H of the seat 22 of the saddled vehicle 10. The obtained height H of the seat 22 is stored in the storage unit 154 by the storage control unit 178 as height information.

Thereafter, at time T22, the saddled vehicle 10 stops acceleration, and the speed V is maintained at a constant speed VB until time T23. As shown in FIG. 4B, the constant speed VB is smaller than the predetermined value V2. That is, the speed V does not exceed the predetermined value V2.

At time T23, the speed V of the saddled vehicle 10 starts to decrease. After the deceleration starts, the speed V of the saddled vehicle 10 drops to the above-mentioned predetermined value V3 at time T24. It is assumed that the height H of the seat 22 of the saddled vehicle 10 is changed by the rider operating the operation unit 192 after it has been determined that the saddled vehicle 10 starts traveling at time T21. In this case, the current height H of the seat 22 is different from the height H stored in the storage unit 154 (the height H at the start of traveling of the saddled vehicle 10).

That is, similarly to the example shown in FIG. 4A, in the example shown in FIG. 4B as well, during traveling of the saddled vehicle 10, the condition is satisfied that the speed V is equal to or less than the predetermined value V3 and that the current height H of the seat 22 is different from the height H of the seat 22 at the start of traveling of the saddled vehicle 10. However, as in the example shown in FIG. 4B, in the case that the condition is satisfied without the speed V exceeding the predetermined value V2, the display control unit 180 does not display the above-described alert on the display unit 194. After that, the deceleration continues further, and at time T25, the saddled vehicle 10 stops, and the speed V thereof becomes 0.

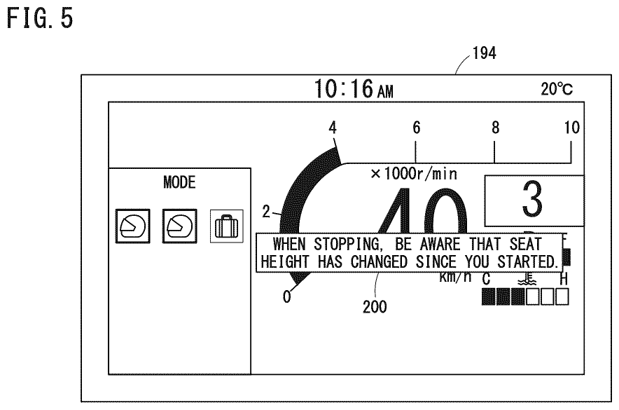

FIG. 5 is a diagram illustrating an example of an alert displayed on the display unit 194. The display unit 194 shown in FIG. 5 is an instrument panel on which the speed V of the saddled vehicle 10 is displayed. When the saddled vehicle 10 is stopped, a message 200 is superimposed on the screen displaying the speed V as an alert indicating that the height H of the seat 22 has been changed. The rider who has seen the alert display can pay attention to the foot grounding property. Therefore, the possibility that the saddled vehicle 10 falls down when the vehicle is stopped is reduced. That is, safety can be enhanced.

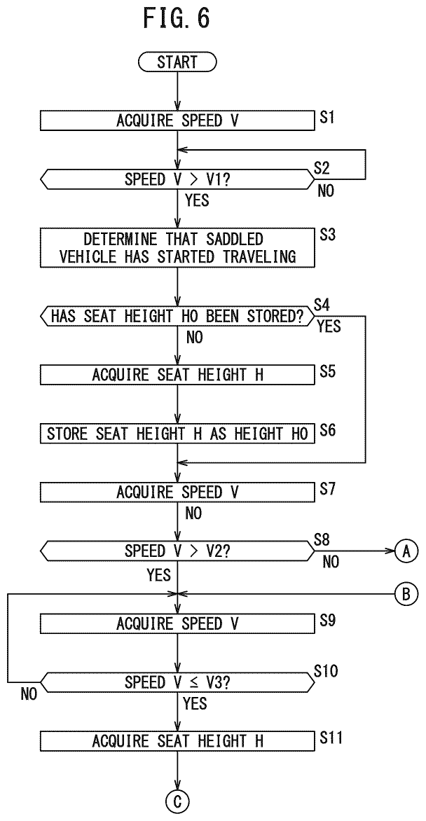

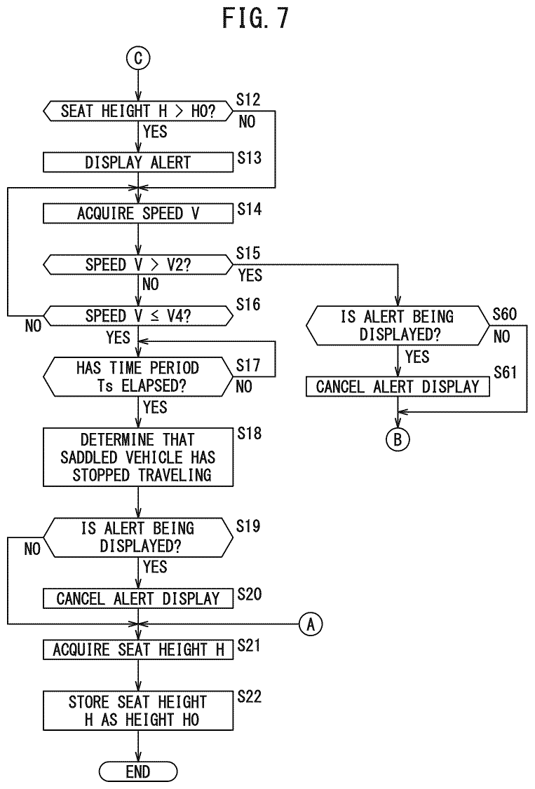

FIGS. 6 and FIG. 7 are flowcharts illustrating a processing sequence of the alert display process regarding a change in the height H of the seat 22 performed by the control device 150. This processing sequence is performed, for example, by the processing circuit 152 of the control device 150 executing a program stored in the storage unit 154. The present processing sequence is started, for example, when a power switch (not shown) of the saddled vehicle 10 is turned on. When the present processing sequence is started, the speed acquisition unit 172 acquires the speed V at which the saddled vehicle 10 travels in step S1.

In step S2, the determination unit 174 determines whether or not the speed V acquired in step S1 is equal to or greater than the predetermined value V1 (e.g., 7 [km/h]). In the case that YES is determined in step S2, the present processing sequence proceeds to step S3. In the case that NO is determined in step S2, the processing sequence repeats the processing sequence in step S2. In step S3, the determination unit 174 determines that the saddled vehicle 10 has started traveling based on the determination result in step S2 regarding the speed V.

In step S4, the height acquisition unit 170 determines whether the height H0 of the seat 22 at the start of traveling of the saddled vehicle 10 has been stored in the storage unit 154. In the case that YES is determined in step S4, the present processing sequence proceeds to step S7. In the case that NO is determined in step S4, the present processing sequence proceeds to step S5. In step S5, the height acquisition unit 170 acquires the height H of the seat 22. In step S6, the storage control unit 178 stores the height H acquired in step S5 in the storage unit 154 as the height HO of the seat 22 at the start of traveling of the saddled vehicle 10.

In step S7, the speed acquisition unit 172 acquires the speed V at which the saddled vehicle 10 travels. In step S8, the determination unit 174 determines whether or not the speed V acquired in step S7 exceeds a predetermined value V2 (for example, 35 [km/h]) stored in the storage unit 154. In the case that YES is determined in step S8, the present processing sequence proceeds to step S9. In the case that NO is determined in step S8, the present processing sequence proceeds to step

S21.

In step S9, the speed acquisition unit 172 acquires the speed V at which the saddled vehicle 10 travels. In step S10, the determination unit 174 determines whether the speed V acquired in step S9 is equal to or less than a predetermined value V3 (for example, 30 [km/h]) stored in the storage unit 154. In the case that the answer to step S10 is YES, as shown in FIG. 4A, the speed V of the saddled vehicle 10 has exceeded the predetermined value V2 (for example, 35 [km/h]) and then has fallen to the predetermined value V3 (for example, 30 [km/h]) or less. In this case, the present processing sequence proceeds to step S11. In the case that NO is determined in step S10, the present processing sequence returns to step S9.

In step S11, the height acquisition unit 170 acquires the current height H of the seat 22. In step S12, the determination unit 174 determines whether the current height H of the seat 22 is different from the height H0 of the seat 22 at the start of traveling of the saddled vehicle 10. The height HO of the seat 22 at the start of traveling of the saddled vehicle 10 is stored in the storage unit 154.

In the present embodiment, in step S12, it is determined whether the current height H of the seat 22 is greater than the height H0 of the seat 22 at the start of traveling of the saddled vehicle 10. However, in step S12, it may be determined whether the current height H of the seat 22 is smaller than the height H0 of the seat 22 at the start of traveling of the saddled vehicle 10. In step S12, it may be determined whether the current height H of the seat 22 is different from the height H0 of the seat 22 at the start of traveling of the saddled vehicle 10.

In the case that YES is determined in step S12, during traveling of the saddled vehicle 10, the condition is satisfied that the speed V is equal to or less than the predetermined value V3 (for example, 30 [km/h]) and the current height H of the seat 22 is different from the height H0 of the seat 22 at the start of traveling of the saddled vehicle 10. In this case, the processing sequence proceeds to step S13. In the case that NO is determined in step S12, the present processing sequence proceeds to step S14.

In step S13, the display control unit 180 displays the alert illustrated in FIG. 5 on the display unit 194. In step S14, the speed acquisition unit 172 acquires the speed V at which the saddled vehicle 10 travels.

In step S15, the determination unit 174 determines whether the speed V acquired in step S15 exceeds the predetermined value V2 (for example, 35 [km/h]) stored in the storage unit 154. In the case that YES is determined in step S15, the present processing sequence proceeds to step S60. In this case, since the saddled vehicle 10 has accelerated, the alert display is cancelled in step S60 and subsequent steps to be described later. In the case that NO is determined in step S15, the present processing sequence proceeds to step S16.

In step S16, the determination unit 174 determines whether the speed V acquired in step S14 is equal to or less than a predetermined value V4 (for example, 5 [km/h]). In the case that YES is determined in step S16, the present processing sequence proceeds to step S17. In the case that NO is determined in step S16, the present processing sequence returns to step S14.

In step S17, the determination unit 174 determines whether or not the time period Ts has elapsed since the determination processing in step S16. In the case that YES is determined in step S17, the present processing sequence proceeds to step $18. In the case that NO is determined in step S17, the processing sequence repeats the processing sequence in step S17.

In step S18, the determination unit 174 determines that the saddled vehicle 10 has stopped traveling based on the fact that the time period Ts has elapsed while the speed V is equal to or lower than the predetermined value V4. In step S19, the display control unit 180 determines whether or not an alert is being displayed on the display unit 194. In the case that YES is determined in step S19, the present processing sequence proceeds to step S20. In the case that NO is determined in step S19, the present processing sequence proceeds to step S21.

In step S20, the display control unit 180 cancels the alert display. In step S21, the height acquisition unit 170 acquires the current height H of the seat 22 at which it is determined that the saddled vehicle 10 has stopped traveling. In step S22, the storage control unit 178 stores the height H (latest value) acquired in step S21 in the storage unit 154 as the height HO of the seat 22 at the start of the next traveling of the saddled vehicle 10. When the processing of step S22 is completed, the present processing sequence is terminated.

In the case that YES is determined in step S15, the present processing sequence proceeds to step S60. In step S60, the display control unit 180 determines whether an alert is being displayed on the display unit 194. In the case that YES is determined in step $60, the present processing sequence proceeds to step S61. In the case that NO is determined in step S60, the present processing sequence returns to above-mentioned step S9. In step S61, the display control unit 180 cancels the alert display. When the processing of step $61 is completed, the present processing sequence returns to above-mentioned step S9.

### Modifications

The above-described embodiment may be modified as follows.

### Modification 1

The height H of the seat 22 of the saddled vehicle 10 may be adjusted in a mode selected in accordance with an operation of the operation unit 192 by the rider. The rider can select one of a plurality of modes relating to the adjustment of the height H of the seat 22 by operating the operation unit 192. The operation unit 192 is, for example, a switch box, or a touchscreen (a touch panel).

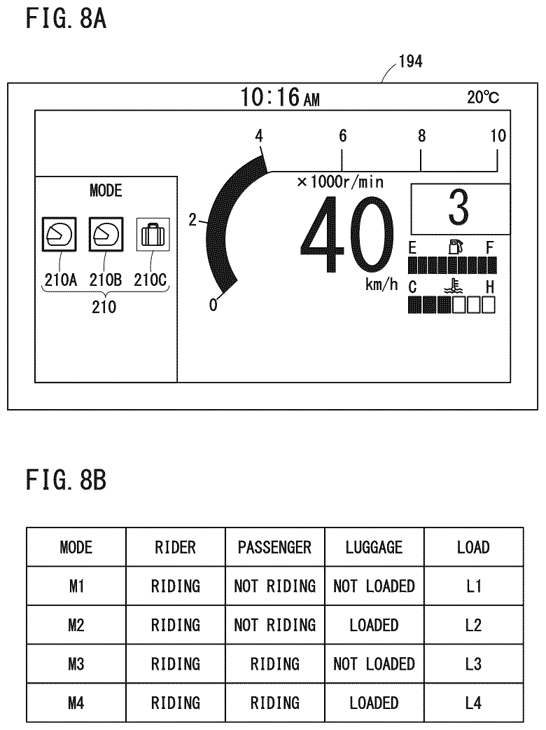

FIG. 8A is a diagram illustrating a screen example of the display unit 194 that displays a result of a mode selected by a rider of the saddled vehicle 10. The display unit 194 shown in FIG. 8A is an instrument panel on which the speed V of the saddled vehicle 10 is displayed. Three icons 210 are displayed on the display unit 194. The three icons 210 indicate settings relating to a load applied to the suspension 16 of the saddled vehicle 10. The three icons 210 include icons 210A, 210B, and 210C.

The icon 210A indicates whether or not a rider driving the saddled vehicle 10 is riding on the saddled vehicle 10. In the case that a rider driving the saddled vehicle 10 is riding on the saddled vehicle 10, the icon 210A is displayed in a selected state. The icon 210A is always selected in a default setting. FIG. 8A shows that the icon 210A is displayed in a selected state.

The icon 210B indicates whether or not a passenger other than the rider of the saddled vehicle 10 is riding on the saddled vehicle 10. In the case that the passenger is riding on the saddled vehicle 10, the icon 210B is displayed in the selected state. When the rider operates the operation unit 192, the icon 210B is displayed in a selected state or an unselected state. FIG. 8A shows that the icon 210B is displayed in a selected state.

The icon 210C indicates whether or not any luggage is loaded on the saddled vehicle 10. In the case that luggage is loaded on the saddled vehicle 10, the icon 210C is displayed in a selected state. When the rider operates the operation unit 192, the icon 210C is displayed in a selected state or an unselected state. FIG. 8A shows that the icon 210C is displayed in an unselected state.

FIG. 8B is a diagram illustrating an example of the types of modes. The modes M1, M2, M3 and M4 shown in FIG. 8B correspond to the above-described modes for adjusting the height H of the seat 22 of the saddled vehicle 10. The modes M1, M2, M3 and M4 are associated with the loads L1, L2, L3 and L4 applied to the suspension 16 of the saddled vehicle 10, respectively. The association between the modes M1, M2, M3, and M4 and the loads L1, L2, L3, and L4 is stored in advance in the storage unit 154.

In the mode M1, the rider driving the saddled vehicle 10 rides on the saddled vehicle 10. There is no passenger other than the rider who drives the saddled vehicle 10. No luggage is loaded on the saddled vehicle 10. That is, the mode M1 is a mode in which only the rider who drives the saddled vehicle 10 rides on the saddled vehicle 10. The load L1 corresponding to the mode M1 is the lightest.

In the mode M2, the rider driving the saddled vehicle 10 rides on the saddled vehicle 10. There is no passenger other than the rider who drives the saddled vehicle 10. Luggage is loaded on the saddled vehicle 10. That is, the mode M2 is a mode in which the rider driving the saddled vehicle 10 rides on the saddled vehicle 10 and the luggage is loaded on the saddled vehicle 10. The load L2 corresponds to the mode M2.

In the mode M3, the rider driving the saddled vehicle 10 rides on the saddled vehicle 10. There is also another passenger other than the rider who drives the saddled vehicle 10. No luggage is loaded on the saddled vehicle 10. That is, the mode M3 is a mode in which both the rider driving the saddled vehicle 10 and the passenger ride on the saddled vehicle 10. The load L3corresponds to the mode M3.

In the mode M4, the rider driving the saddled vehicle 10 rides on the saddled vehicle 10. There is also another passenger other than the rider who drives the saddled vehicle 10. Luggage is loaded on the saddled vehicle 10. That is, the mode M4 is a mode in which both the rider driving the saddled vehicle 10 and the passenger ride on the saddled vehicle 10, and in which the luggage is loaded on the saddled vehicle 10. The load L4corresponding to the mode M4 is the heaviest.

While the saddled vehicle 10 is traveling, the rider selects one mode by operating the operation unit 192. In this case, the adjustment control unit 176 of the processing circuit 152 controls the adjustment unit 40 to apply a load corresponding to the selected mode to the suspension 16. Thus, the adjustment control unit 176 adjusts the height H of the seat 22 while the saddled vehicle 10 is running. For example, in the case that the mode M3 is selected, the load L3 is applied to the suspension 16. In correspondence with the mode M3, as shown in FIG. 8A, each of the icons 210A and 210B is displayed in a selected state.

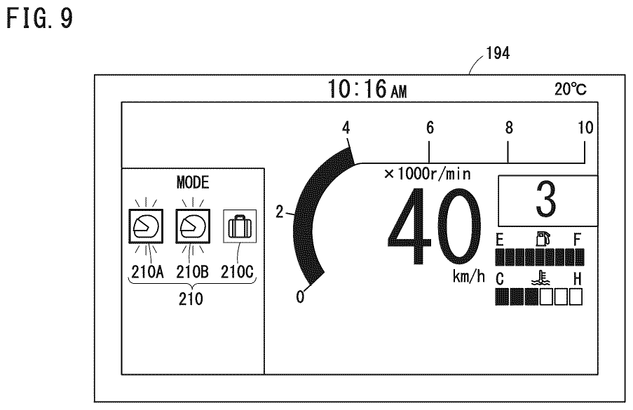

FIG. 9 is a diagram showing an example of an alert displayed on the display unit 194. In FIG. 9, when the saddled vehicle 10 is stopped, at least a part of the three icons 210 is displayed while blinking as an alert indicating that the height H of the seat 22 has been changed. Specifically, one or more of the icons 210 displayed in the selected state among the icons 210A, 210B, and 210C blink.

For example, in a case that the icons 210A and 210B are displayed in a selected state as shown in FIG. 8A, the icons 210A and 210B blink as shown in FIG. 9. By blinking the icons 210A and 210B, an alert indicating that the height H of the seat 22 has been changed is displayed. The rider who has seen the alert display can pay attention to the foot grounding property. Therefore, the possibility that the saddled vehicle 10 falls down when the vehicle stops is reduced. That is, safety can be enhanced.

### Modification 2

The height H of the seat 22 of the saddled vehicle 10 may be adjusted based on a set value input by the rider. The rider can input the set value of the height H of the seat 22 to the control device 150 by operating the operation unit 192. The operation unit 192 is, for example, a switch box, or a touchscreen (a touch panel).

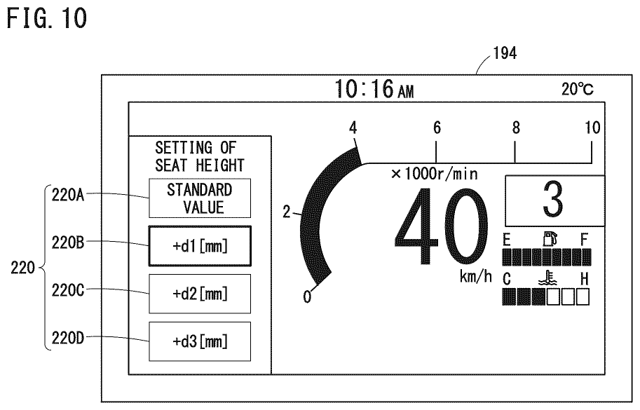

FIG. 10 is a diagram illustrating a screen example of the display unit 194 displaying a result of inputting a set value of the height H of the seat 22 to the control device 150 by the rider of the saddled vehicle 10. The display unit 194 shown in FIG. 10 is an instrument panel on which the speed V of the saddled vehicle 10 is displayed. A plurality of icons 220 are displayed on the display unit 194. The plurality of icons 220 include icons 220A, 220B, 220C, and 220D that are selected by the rider to input a set value for the height H of the seat 22.

The icon 220A indicates that the height H of the seat 22 is set to a standard value selected in a default setting. The icon 220B indicates that the height H of the seat 22 is set to a value higher than the standard value by d1 [mm]. The icon 220C indicates that the height H of the seat 22 is set to a value higher than the standard value by d2 [mm]. The icon 220D indicates that the height H of the seat 22 is set to a value higher than the standard value by d3 [mm]. FIG. 10 shows that the icon 220B is displayed in a selected state.

While the saddled vehicle 10 is traveling, the rider operates the operation unit 192 to input a set value of the height H of the seat 22. In this case, the adjustment control unit 176 of the processing circuit 152 controls the adjustment unit 40 to adjust the height H of the seat 22 to the set value input by the rider.

### Invention Obtained from Embodiment

A description will be given below concerning invention that can be grasped from the above-described embodiment and the modifications.

(1) The saddled vehicle (10) includes the adjustment unit (40) configured to adjust the height (H) of the seat (22) of the saddled vehicle, and the control device (150) configured to control the adjustment unit to adjust the height (H) of the seat, wherein the control device includes the height acquisition unit (170) configured to acquire the height of the seat, the speed acquisition unit (172) configured to acquire the speed (V) at which the saddled vehicle travels, and the display control unit (180) configured to display the alert on the display unit (194) in the case that, during traveling of the saddled vehicle, the condition is satisfied that the speed is equal to or less than the first predetermined value (V3) and the height is different from the height (H0) at the start of the traveling of the saddled vehicle. In accordance with such a configuration, it is possible to draw the attention of the rider riding on the saddled vehicle with respect to the foot grounding property of the rider. Therefore, safety can be enhanced.

(2) The display control unit may display the alert on the display unit in the case that the condition is satisfied after the speed exceeds the second predetermined value (V2) larger than the first predetermined value, and need not necessarily display the alert on the display unit in the case that the speed does not exceed the second predetermined value. In accordance with such a configuration, in the case that the saddled vehicle travels at a low speed and then stops, the alert display can be prevented. In the case that the saddled vehicle travels at a low speed and then stops, the possibility that the rider falls down together with the saddled vehicle is low, and therefore, the necessity of displaying the alert is low.

(3) The control device may further include the storage control unit (178) configured to store the height at the start of the traveling as height information in the storage unit (154). In accordance with such a configuration, it is possible to detect a change in the height of the seat of the saddled vehicle.

(4) The control device may further include the determination unit (174) configured to determine, based on the speed, whether the saddled vehicle has stopped, and the storage control unit may update the height information stored in the storage unit to the height at the stoppage of the saddled vehicle. In accordance with such a configuration, the need to acquire the height of the seat at the start of the next traveling of the saddled vehicle can be eliminated.

(5) The control device may further include the determination unit (174) configured to determine, based on the speed, whether the saddled vehicle has stopped, and in the case that the saddled vehicle is stopped, the display control unit may cancel the display of the alert. In accordance with such a configuration, the alert display is prevented from being performed even when the saddled vehicle has stopped without falling. Therefore, the inconvenience to the rider of the saddled vehicle is reduced.

(6) The saddled vehicle may further include the operation unit (192) configured for the rider of the saddled vehicle to select one mode from the plurality of modes (M1, M2, M3, M4) relating to adjustment of the height, and the control device may further include the adjustment control unit (176) configured to control the adjustment unit to apply the load corresponding to the one mode that has been selected, to the suspension (16) of the saddled vehicle, in order to adjust the height. In accordance with such a configuration, the rider can easily select a mode during the traveling of the saddled vehicle.

(7) The plurality of modes may include the mode (M1) in which only the rider rides on the saddled vehicle, the mode (M3) in which the rider and the passenger ride on the saddled vehicle, and a mode (M2) in which the rider rides on the saddled vehicle and the luggage is loaded on the saddled vehicle. In accordance with such a configuration, the rider can adjust the height of the seat in accordance with the load applied to the suspension of the saddled vehicle.

(8) The saddled vehicle may further include the operation unit (192) configured for the rider of the saddled vehicle to input the set value of the height, wherein the control device may further include the adjustment control unit (176) configured to control the adjustment unit to adjust the height to the set value. In accordance with such a configuration, the rider can easily adjust the height of the seat during the traveling of the saddled vehicle.

Moreover, the present invention is not limited to the above-described disclosure, and various configurations can be adopted therein without departing from the essence and gist of the present invention.
What is claim is:

1. 1-8. (canceled)

9. A saddled vehicle, comprising:
an adjustment unit configured to adjust a height of a seat of the saddled vehicle; and
a control device configured to control the adjustment unit to adjust the height of the seat,
wherein the control device includes one or more processors that execute computer-executable instructions stored in a memory, wherein the one or more processors execute the computer-executable instructions to cause the control device to:
acquire the height of the seat;
acquire a speed at which the saddled vehicle travels; and
display an alert on a display unit in a case that, during traveling of the saddled vehicle, a condition is satisfied that the speed is equal to or less than a first predetermined value and the height is different from the height at a start of the traveling of the saddled vehicle.

10. The saddled vehicle according to claim 9, wherein the alert is displayed on the display unit in a case that the condition is satisfied after the speed exceeds a second predetermined value larger than the first predetermined value, and the alert is not displayed on the display unit in a case that the speed does not exceed the second predetermined value.

11. The saddled vehicle according to claim 9, wherein the one or more processors execute the computer-executable instructions to cause the control device to further store the height at the start of the traveling as height information in a storage unit.

12. The saddled vehicle according to claim 11, wherein the one or more processors execute the computer-executable instructions to cause the control device to further:
determine, based on the speed, whether the saddled vehicle has stopped; and
update the height information stored in the storage unit to the height at a stoppage of the saddled vehicle.

13. The saddled vehicle according to claim 9, wherein the one or more processors execute the computer-executable instructions to cause the control device to further:
determine, based on the speed, whether the saddled vehicle has stopped; and
in a case that the saddled vehicle is stopped, cancel display of the alert.

14. The saddled vehicle according to claim 9, further comprising an operation unit configured for a rider of the saddled vehicle to select one mode from a plurality of modes relating to adjustment of the height,
wherein the one or more processors execute the computer-executable instructions to cause the control device to further control the adjustment unit to apply a load corresponding to the one mode that has been selected, to a suspension of the saddled vehicle, in order to adjust the height.

15. The saddled vehicle according to claim 14, wherein the plurality of modes include a mode in which only the rider rides on the saddled vehicle, a mode in which the rider and a passenger ride on the saddled vehicle, and a mode in which the rider rides on the saddled vehicle and luggage is loaded on the saddled vehicle.

16. The saddled vehicle according to claim 9, further comprising an operation unit configured for a rider of the saddled vehicle to input a set value of the height,
wherein the one or more processors execute the computer-executable instructions to cause the control device to further control the adjustment unit to adjust the height to the set value.
